(19) United States
(12) Patent Application Publication
(10) Pub. No.: US 2018/0338225 A1
(43) Pub. Date: Nov. 22, 2018

(54) HUMAN OCCUPANCY DETECTION IN A TRANSPORTATION VEHICLE

(71) Applicant: FUJITSU LIMITED, Kawasaki-shi (JP)

(72) Inventor: Sho SHIMIZU, San Jose, CA (US)

(73) Assignee: FUJITSU LIMITED, Kawasaki-shi (JP)

(21) Appl. No.: 15/602,094

(22) Filed: May 22, 2017

(51) Int. Cl. H04W 4/04; H04W 4/02

(52) U.S. Cl. CPC H04W 4/046; G06Q 2240/00; H04W 4/027

(57) ABSTRACT

A method to determine a number of occupants in a transportation vehicle may include receiving a first indication of a first location, a first speed, a first acceleration, and a first time associated with a first device, and a second indication of a second location, a second speed, a second acceleration, and a second time associated with a second device. The method also includes determining whether the first device and the second device are in a same transportation vehicle based on a comparison of the first indication and the second indication.

### FIELD

The described technology relates generally to detecting occupancy in transportation vehicles.

### BACKGROUND

There is increasing interest in determining the number of human occupants in transportation vehicles, such as automobiles, buses, trains, etc. High-occupancy vehicle (HOV) lanes are restricted lanes typically reserved for use by motor vehicles with a driver and one or more passengers. High Occupancy Tolling (HOT) lanes determine the toll amount according to the number of occupants in the vehicles. Ride-share services, such as uberPOOL, determine the fare for the passengers according to the number of passengers who shared the ride. The premise is to reward carpooling and sharing with other riders in order to reduce the number of vehicles on the roadway.

Unfortunately, violation of the occupancy requirements does occur. For example, use of the HOV lanes by single occupant motor vehicles reduces the intended benefits of moving more people in fewer vehicles. Where automated tolling systems are in place for the HOT lanes, improperly declaring the number of occupants in the motor vehicle results in reduced revenue. This similarly applies to ride-share services that typically rely on the driver (e.g., employee) to correctly charge the passengers.

The subject matter claimed in the present disclosure is not limited to embodiments that solve any disadvantages or that operate only in environments such as those described above. Rather, this background is only provided to illustrate one example technology area where some embodiments described in the present disclosure may be practiced.

### SUMMARY

According to some examples, systems configured to determine a number of occupants in a transportation vehicle are described. An example system configured to determine a number of occupants in a transportation vehicle may include a memory configured to store instructions and a processor configured to execute the instructions. Execution of the instructions may cause the processor to receive a first indication of a first location, a first speed, a first acceleration, and a first time, where the first indication may be associated with a first device, and receive a second indication of a second location, a second speed, a second acceleration, and a second time, where the second indication may be associated with a second device. Execution of the instructions may cause the processor to also determine whether the first device and the second device are in a same transportation vehicle based on a comparison of the first indication and the second indication.

The objects and advantages of the embodiments will be realized and achieved at least by the elements, features, and combinations particularly pointed out in the claims. Both the foregoing general description and the following detailed description are given as examples, are explanatory and are not restrictive of the invention, as claimed.

### BRIEF DESCRIPTION OF THE DRAWINGS

The foregoing and other features of this disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings, in which:

FIG. 1 illustrates an overview of an environment in which an occupancy detection system may operate;

FIG. 2 is a high-level block diagram that illustrates interactions between various components associated with the occupancy detection system;

FIG. 3 illustrates a general purpose computing system, which may be used to determine a number of occupants in a transportation vehicle;

FIG. 4 is a flow diagram that illustrates an example process to determine a number of persons in a transportation vehicle;

FIG. 5 is a sequence diagram illustrating flows of information to provide high-occupancy vehicle (HOV) lane aware navigation; and

FIG. 6 is a flow diagram that illustrates an example process to provide HOV lane aware navigation, all arranged in accordance with at least some embodiments described herein.

### DESCRIPTION OF EMBODIMENTS

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. The aspects of the present disclosure, as generally described herein, and illustrated in the Figures, can be arranged, substituted, combined, separated, and designed in a wide variety of different configurations, all of which are explicitly contemplated herein.

This disclosure is generally drawn, inter alia, to methods, apparatus, systems, devices, and/or computer program products related to transportation vehicle occupancy determination based on location, speed, acceleration, and time information.

Technology is generally described for using location, speed (including direction), acceleration, and time information to determine transportation vehicle occupancy. The technology leverages the increasing trend that people typically have a mobile device, such as, by way of example, a smartphone, which can provide location, speed, and acceleration information, in their possession when they travel. The technology makes a determination as to whether two mobile devices, each mobile device in the possession of a respective person, are in the same transportation vehicle based on a comparison of location, speed, acceleration, and time information associated with each mobile device.

In some embodiments, the technology may provide an occupancy detection application program (also referred to herein as an application program or application) for execution on mobile devices that transmit or provide the location, speed, and acceleration information of the respective mobile device. The technology may provide an incentive for people to load and execute the application program on their mobile devices. Accordingly, a person willing to provide location and movement information may load and execute the application program on their mobile device. While executing, the application program, using the location sensor and acceleration sensor of the mobile device, may periodically transmit the location, speed, and acceleration information of the mobile device. The application program may also provide an indication of a time with each location, speed, and acceleration information. The person may subsequently stop execution of the application program to cease providing location and movement information of the person.

The technology may assign an identifier to each location, speed, acceleration, and time information. The identifier may identify the application program and/or mobile device that transmitted the location, speed, acceleration, and time information. For example, the application program executing on the mobile device may provide an identifier that identifies the application program with the periodically transmitted location, speed, acceleration, and time information. In instances where the application program executing on the mobile device does not provide the time information, the technology may determine the time information as the time of receipt of the location, speed, and acceleration information. The technology may maintain this information (e.g., identifier, location, speed, acceleration, and time) in a location history data store. The technology may then compare the location, speed, acceleration, and time information for the different identifiers to determine whether two persons (e.g., two identifiers) are sufficiently proximate to each other to determine that the two persons are in a same transportation vehicle. The premise is that two persons who are located near each other and moving at the same speed and acceleration at the same time or times are in close proximity to each other.

For example, to allow the technology to determine whether people are occupying the same transportation vehicle, a person may start executing the application program on their mobile device upon entering or boarding the transportation vehicle. Once executing, the application program may periodically transmit location, speed, acceleration, and time information of the mobile device. The application program may also transmit an identifier with the location, speed, acceleration, and time information. Since the person is in possession of the mobile device, the location, speed, acceleration, and time information of the mobile device is also the location, speed, acceleration, and time information of the person. The technology may receive the transmitted identifier, location, speed, acceleration, and time information, and, from the identifier, associate a sender (e.g., identify the sender) to the received information. As the person is in the transportation vehicle, the speed and acceleration may be the speed and acceleration of the transportation vehicle.

When another person boards the transportation vehicle, that person may start executing the application program on their mobile device. Once executing, the application program may periodically transmit an identifier and the location, speed, acceleration, and time information of the mobile device, and the technology may associate a sender to the received location, speed, acceleration, and time information. Similarly, as this person is also riding on the transportation vehicle, the speed and acceleration may also be the speed and acceleration of the transportation vehicle. The technology may then compare the location, speed, acceleration, and time information for these two persons (e.g., identifiers) to determine whether the two persons are in the same transportation vehicle. For example, in the instance the transportation vehicle is an automobile, the location of the two persons may be such that the two persons are located within distance that is approximate to the dimensions of an automobile. As another example, in the instance the transportation vehicle is a train car, the location of the two persons may be such that the two persons are located within distance that is approximate to the dimensions of a train car. In some embodiments, a database may store the dimensions of different types of transportation vehicles. The size may be defined as width (side-to-side)×length (front-to-back).

When yet another person boards the transportation vehicle, that person may start executing the application program on their mobile device. Once executing, the application program may periodically transmit an identifier and the location, speed, acceleration and time information of the mobile device, and the technology may associate a sender to the received location, speed, acceleration, and time information. Similarly, as this person is also riding on the transportation vehicle, the speed and acceleration may also be the speed and acceleration of the transportation vehicle. The technology may then compare the location, speed, acceleration, and time information for this person (e.g., the identifier associated with this person) with the location, speed, acceleration, and time information of either or both of the other two persons (e.g., the identifiers associated with the other two persons, respectively) to determine whether the three persons are in the transportation vehicle.

In some embodiments, the technology may indicate persons in the same transportation vehicle as being in a group. For example, the technology may associate or group the identifiers that respectfully identify the persons (the identifiers that respectfully identify the mobile devices and/or the application programs executing on the respective mobile devices in the possession of the persons) in the same transportation vehicle to indicate that the associated persons are in the same transportation vehicle. In some embodiments, the technology may maintain a count of the number of occupants in the same transportation vehicle. Continuing the example above, the count of the number of occupants in the transportation vehicle is three. Subsequently, if the second person who boarded the transportation vehicle is to get off (e.g., de-board) the same transportation vehicle, the technology may determine that that person is no longer in the same transportation vehicle with the other two persons based on the location, speed, acceleration, and/or time information associated with the de-boarded person. That is, the application program executing on the mobile device of the de-boarded person may be transmitting location, speed and acceleration information sufficiently different than the location, speed and acceleration information being transmitted by the mobile devices of the persons still remaining in the transportation vehicle. Upon determining that the de-boarded person is no longer in the transportation vehicle, the technology may appropriately reduce the count of the number of occupants in the transportation vehicle. The technology may also identify and/or indicate the de-boarded person as no longer being in the same transportation vehicle.

In some embodiments, the technology may provide the count of the number of occupants in a transportation vehicle to an application program executing on a mobile device that is transmitting its location, speed, acceleration, and time information. For example, contemporaneously with transmitting a location, speed, acceleration, and time information of a mobile device, the application program may request that a count of the number of occupants in the transportation vehicle (e.g., the transportation vehicle that the person in possession of the mobile device is in) be provided to the application program. The technology may then provide a revised or updated count of the number of occupants in the transportation vehicle upon determining a change to the previously provided count.

In some embodiments, the technology may require a person to register with the technology prior to using the application program. The registration may include the person establishing authentication credentials, such as, by way of example, a username and password, biometric data, and/or the like, that may be requested prior to execution of the application program. For example, the application program may request the person to provide proper authentication credentials as part of executing on a mobile device. The application program may then provide the received authentication credentials to the technology, for example, with the location, speed, acceleration, and time information. The technology may then use the authentication credentials to associate the person with the location, speed, acceleration, and time information provided by the application program executing on the mobile device of the person. The technology may also use the authentication credentials to ensure that the person is not executing multiple instances of the application program either on the same or different mobile devices. For example, once the technology starts receiving location, speed, acceleration, and time information associated with a specific authentication credential provided by an executing instance of the application program, the technology may discard location, speed, acceleration, and/or time information associated with the same authentication credential provided by different executing instances of the application program. In some embodiments, once an authentication credential is used to execute the application program and while the application program continues to execute, the application program may not allow the use of the same authentication credentials to execute a different instance of the application program.

In some embodiments, the application program may allow the mobile device to be associated with multiple persons. For example, a person in possession of the mobile device may be with an additional person or persons (e.g., children, babies, other adults, and the like) who may not have mobiles devices with the application program. In this instance, the application program may be configured to receive an indication of a number of persons the application program should account for. For example, a person traveling with a child can indicate to the application program that it should account for two persons instead of one. The application program may then provide the technology with the count of the number of persons to associate with its readings (e.g., its transmitted location, speed, acceleration, and time information).

In some embodiments, the application program may be configured to receive visual input (e.g., video of the additional persons, etc.) using the visual sensor of the mobile device to verify that the additional persons are with the person in possession of the mobile device on which the application program is executing. In some embodiments, the application program may be configured to receive acoustic input (e.g., voices or sounds generated by the additional persons, etc.) using the acoustic sensor of the mobile device to verify that the additional persons are with the person in possession of the mobile device on which the application program is executing. In some embodiments, the application program may be configured to detect communication from remote devices, such as, by way of example, radio-frequency identification (RFID) tags, Bluetooth enabled devices, and/or the like, to verify that the additional persons are with the person in possession of the mobile device on which the application program is executing. For example, each of the other persons may be wearing or be in possession of a remote device that transmits signals that may be received by the mobile device on which the application program is executing. The application program may be further configured to periodically confirm that the additional persons without mobile devices (e.g., not in possession of mobile devices executing the application program) are still with the person in possession of the mobile device. For example, the application program may periodically request that the appropriate input (e.g., video, acoustic, signals from remote devices, etc.) be provided to verify and confirm that the additional persons are still with the person.

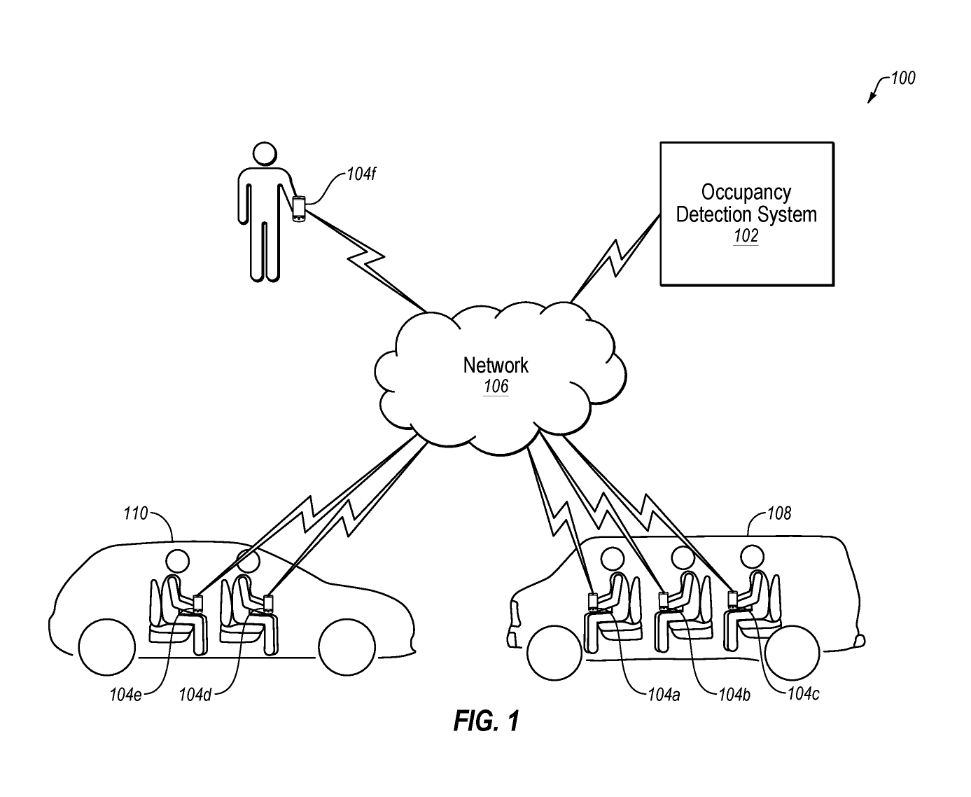

Various embodiments of the technology are described in detail in reference to the Figures. FIG. 1 illustrates an overview of an environment 100 in which an occupancy detection system 102 may operate, arranged in accordance with at least some embodiments described herein. Occupancy detection system 102 may implement various aspects of the technology. As depicted, occupancy detection system 102 is illustrated as operating in a networked environment using logical connections to one or more remote mobile devices 104a, 104b, 104c, 104d, 104e, and 104f, through a network 106. Network 106 can be a local area network, a wide area network, the Internet, and/or other wired or wireless networks.

Mobile devices 104a-104f may be individually referred to herein as mobile device 104 or collectively referred to herein as mobile devices 104. Mobile devices 104 may communicate with occupancy detection system 102 to facilitate determination of the number of occupants in a transportation vehicle and/or to facilitate applications based on the number of occupants in a transportation vehicle, as described herein. The number of mobile devices depicted in environment 100 is for illustration, and one skilled in the art will appreciate that there may be a different number of mobile devices.

A person may be in possession of each mobile device 104, and employ mobile device 104 to provide the location, speed, and acceleration information of the person. Mobile device 104 may include location sensor, such as a Global Positioning System (GPS) module, and an acceleration sensor, such as an accelerometer. Mobile device 104 may include an application program configured to transmit to occupancy detection system 102 the current location, speed and acceleration information of mobile device 104. For example, the device's current location may be determined using the location sensor, and the speed and acceleration may be determined using the acceleration sensor.

When a person in possession of mobile device 104 executes the application program, the application program may periodically transmit the location, speed, and acceleration information of mobile device 104 to occupancy detection system 102. The application program may also transmit an identifier and a time with each information transmission. The identifier may identify the application program (e.g., instance of the executing application program), mobile device 104, and/or the person in possession of mobile device 104. The time may be a time that mobile device 104 obtained the location, speed, and acceleration information, for example, using its sensors, such as the location sensor and the acceleration sensor. Occupancy detection system 102 may be configured to compare location, speed, acceleration, and time information of a person with location, speed, acceleration, and time information of one or more other persons to determine whether one or more of the persons are occupying the same transportation vehicle.

In the illustrated environment 100, each mobile device 104 may be periodically transmitting an identifier and location, speed, acceleration, time information. Based on a comparison of the periodically provided information, occupancy detection system 102 may determine that mobile devices 104a, 104b, and 104c are sufficiently close to each other. That is, occupancy detection system 102 may determine that the location, speed, and acceleration information at specific points in time provided by mobile devices 104a, 104b, and 104c are sufficiently close to conclude that mobile devices 104a, 104b, and 104c are in the same transportation vehicle, for example, a transportation vehicle 108. As a result, occupancy detection system 102 may conclude that the persons in possession of the mobile devices 104a, 104b, and 104c are occupying the same transportation vehicle. In a similar manner, occupancy detection system 102 may conclude that the persons in possession of mobile devices 104d and 104e are occupying the same transportation vehicle, for example, a transportation vehicle 110. Occupancy detection system 102 may conclude that the person in possession of mobile device 104f is alone and not in a transportation vehicle. For example, occupancy detection system 102 may determine from the speed and/or acceleration information provided by mobile device 104f that the person in possession of mobile device 104f is likely not traveling in a transportation vehicle. Moreover, occupancy detection system 102 may determine from a comparison of the location, speed, acceleration, and time information provided by mobile device 104f with the location, speed, acceleration, and time information provided by other mobile devices that the person in possession of mobile device 104f is likely alone and not in a group with another person or persons.

In some embodiments, the application program provided on mobile device 104 may be configured to request the number of occupants in the same transportation vehicle from occupancy detection system 102. For example, the person in possession of mobile device 104 may want to know the number of occupants in the same transportation vehicle the person is on. Occupancy detection system 102 may be configured to provide a count of the number of occupants in the same transportation vehicle the person is on to the application program executing on the mobile device of the person. In some embodiments, occupancy detection system 102 may be configured to provide an updated count of the number of occupants in the same transportation vehicle upon detecting or determining a change to the count of the number of occupants in the same transportation vehicle.

In some embodiments, the application program provided on mobile device 104 may be configured to associate a multiple number of persons to the transmitted location, speed, acceleration, and time information. For example, the application program may provide a user interface that allows a user (e.g., a person in possession of the mobile device) to input an indication of the number of persons that are associated with the mobile device on which the application program is executing. In some embodiments, the application program may be configured to receive visual input to determine the number of additional persons to associate with the mobile device. For example, the person may use the mobile device to provide video images of the additional persons to the application program. In some embodiments, the application program may be configured to receive acoustic input to determine the number of additional persons to associate with the mobile device. For example, the person may use the mobile device to provide audible sounds generated by the additional persons to the application program. In some embodiments, the application program may be configured to detect communication from remote devices to determine the number of additional persons to associate with the mobile device. For example, each additional persons may be in possession of a device, such as, by way of example, radio-frequency identification (RFID) tag, Bluetooth enabled device, and/or the like, that transmits signals with which the application program may determine the number of additional persons.

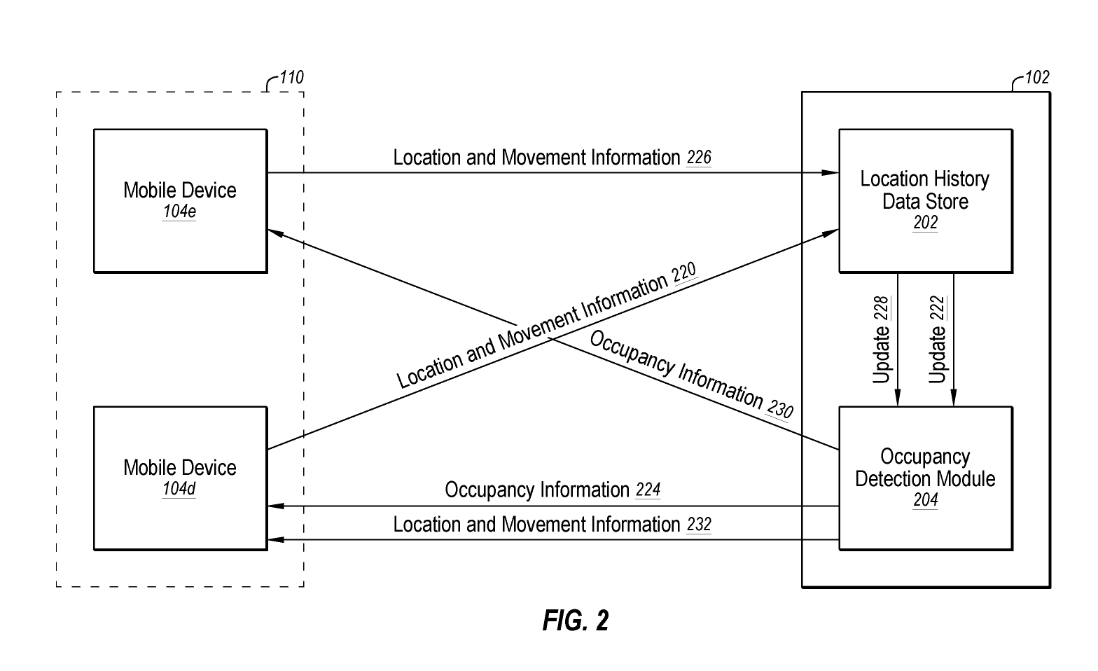

FIG. 2 is a high-level block diagram that illustrates interactions between various components associated with occupancy detection system 102, arranged in accordance with at least some embodiments described herein. Occupancy detection system 102 may include a location history data store 202 and an occupancy detection module 204. Location history data store 202 may be configured to store the identifiers and corresponding location, speed, acceleration, and time information provided by the mobile devices. In some embodiments, location history data store 202 may be configured to assign an identifier, such as a user identifier, to the location, speed, acceleration, and time information in instances where an identifier may not have been provided with the received location, speed, acceleration, and time information.

In some embodiments, location history data store 202 may be configured to determine or detect updates or changes to the location, speed, acceleration, and time information, and invoke occupancy detection module 204. Occupancy detection module 204 may be configured to determine occupants of a transportation vehicle based on comparisons of the location, speed, acceleration, and time information for different identifiers. The premise is that an identifier (e.g., mobile device) that is located near (close to) another mobile device at a given or specific time or times, and where the two mobile devices are moving at the same speed and acceleration at the same time or times may be considered to be in close proximity to each other. Depending on the proximity of the locations (e.g., proximately located within the dimensions of a transportation vehicle) and the speeds (e.g., speed of a transportation vehicle), the two mobile devices may be considered to be in the same transportation vehicle.

For example, a first person may board a transportation vehicle, for example, transportation vehicle 110, and execute an application on mobile device 104d of the first person. The executing application may periodically transmit an identifier and location, speed, acceleration, and time information of mobile device 104 (Location and Movement Information 220) to location history data store 202. Location history data store 202 may store the identifier, location, speed, acceleration, and time information periodically transmitted by the application on mobile device 104d. Upon detecting a change or update to the information (e.g., location, speed, and/or acceleration) associated with the first person, location history data store 202 may invoke (Update 222) occupancy detection module 204. Occupancy detection module 204 may compare the location, speed, acceleration, and time information of the first person from location history data store 202 to location, speed, acceleration, and time information of other persons from location history data store 202 to determine the occupants in the same transportation vehicle (e.g., transportation vehicle 110) with the first person.

Suppose that there are no other persons located near the first person. In this instance, occupancy detection module 204 may compare the location, speed, acceleration, and time information of the first person with the other location, speed, acceleration, and time information in location history data store 202 and determine that the first person is the only occupant of transportation vehicle 110. Occupancy detection module 204 may provide an indication of the occupants in transportation vehicle 110 (Occupancy Information 224) to the application on mobile device 104d (e.g., the mobile device of the first person). For example, occupancy detection module 204 may indicate that there are no other occupants, other than the first person, in transportation vehicle 110. Additionally or alternatively, occupancy detection module 204 may indicate that there is a total of 1 occupant (e.g., the first person) in transportation vehicle 110. That is, occupancy detection module 204 may maintain a count of the number of occupants in transportation vehicle 110, and provide the count of the number of occupants in transportation vehicle 110.

Contemporaneously with or subsequent to the first person boarding transportation vehicle 110, a second person may board transportation vehicle 110, and execute an application on mobile device 104e of the second person. The executing application may periodically transmit an identifier and location, speed, acceleration, and time information of mobile device 104e (Location and Movement Information 226) to location history data store 202. Location history data store 202 may store the identifier, location, speed, acceleration, and time information periodically transmitted by the application on mobile device 104e. Upon receiving an update to location and movement information in location history data store 202 (e.g., location, speed, and/or acceleration information transmitted by the application on mobile device 104e), location history data store 202 may invoke (Update 222) occupancy detection module 204.

For example, occupancy detection module 204 may compare the location, speed, acceleration, and time information of the second person with the other location, speed, acceleration, and time information in location history data store 202 and determine that the second person and the first person are in transportation vehicle 110. Occupancy detection module 204 may provide an indication of the occupants in transportation vehicle 110 (Occupancy Information 230) to the application on mobile device 104e (e.g., the mobile device of the second person). Occupancy detection module 204 may also provide an indication of the revised occupants in transportation vehicle 110 (Update Occupancy Information 232) to the application on mobile device 104d (e.g., the mobile device of the first person).

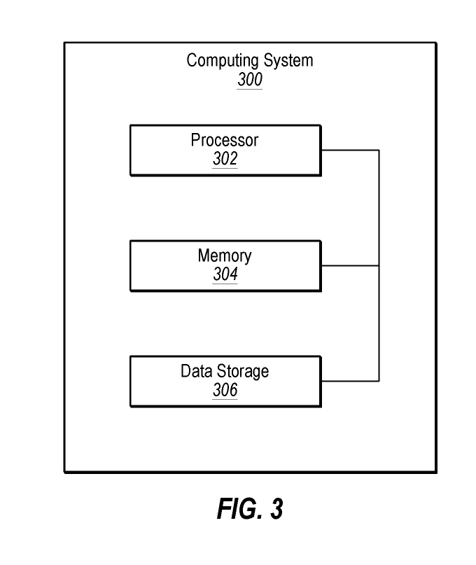

FIG. 3 illustrates a general purpose computing system 300, which may be used to determine a number of occupants in a transportation vehicle, arranged in accordance with at least some embodiments described herein. Computing system 300 may be configured to implement or direct one or more operations associated with some or all of the components and/or modules associated with occupancy detection system 102 and/or mobile device 104 of FIG. 1. Computing system 300 may include a processor 302, a memory 304, and a data storage 306. Processor 302, memory 304, and data storage 306 may be communicatively coupled.

In general, processor 302 may include any suitable special-purpose or general-purpose computer, computing entity, or computing or processing device including various computer hardware, firmware, or software modules, and may be configured to execute instructions, such as program instructions, stored on any applicable computer-readable storage media. For example, processor 302 may include a microprocessor, a microcontroller, a digital signal processor (DSP), an application-specific integrated circuit (ASIC), a Field-Programmable Gate Array (FPGA), or any other digital or analog circuitry configured to interpret and/or to execute program instructions and/or to process data. Although illustrated as a single processor in FIG. 3, processor 302 may include any number of processors and/or processor cores configured to, individually or collectively, perform or direct performance of any number of operations described in the present disclosure. Additionally, one or more of the processors may be present on one or more different electronic devices, such as different servers.

In some embodiments, processor 302 may be configured to interpret and/or execute program instructions and/or process data stored in memory 304, data storage 306, or memory 304 and data storage 306. In some embodiments, processor 302 may fetch program instructions from data storage 306 and load the program instructions in memory 304. After the program instructions are loaded into memory 304, processor 302 may execute the program instructions.

For example, in some embodiments, any one or more of the components and/or modules of occupancy detection system 102 may be included in data storage 306 as program instructions. Processor 302 may fetch some or all of the program instructions from the data storage 306 and may load the fetched program instructions in memory 304. Subsequent to loading the program instructions into memory 304, processor 302 may execute the program instructions such that the computing system may implement the operations as directed by the instructions.

Memory 304 and data storage 306 may include computer-readable storage media for carrying or having computer-executable instructions or data structures stored thereon. Such computer-readable storage media may include any available media that may be accessed by a general-purpose or special-purpose computer, such as processor 302. By way of example, and not limitation, such computer-readable storage media may include tangible or non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to carry or store particular program code in the form of computer-executable instructions or data structures and which may be accessed by a general-purpose or special-purpose computer. Combinations of the above may also be included within the scope of computer-readable storage media. Computer-executable instructions may include, for example, instructions and data configured to cause processor 302 to perform a certain operation or group of operations.

Modifications, additions, or omissions may be made to computing system 300 without departing from the scope of the present disclosure. For example, in some embodiments, computing system 300 may include any number of other components that may not be explicitly illustrated or described herein.

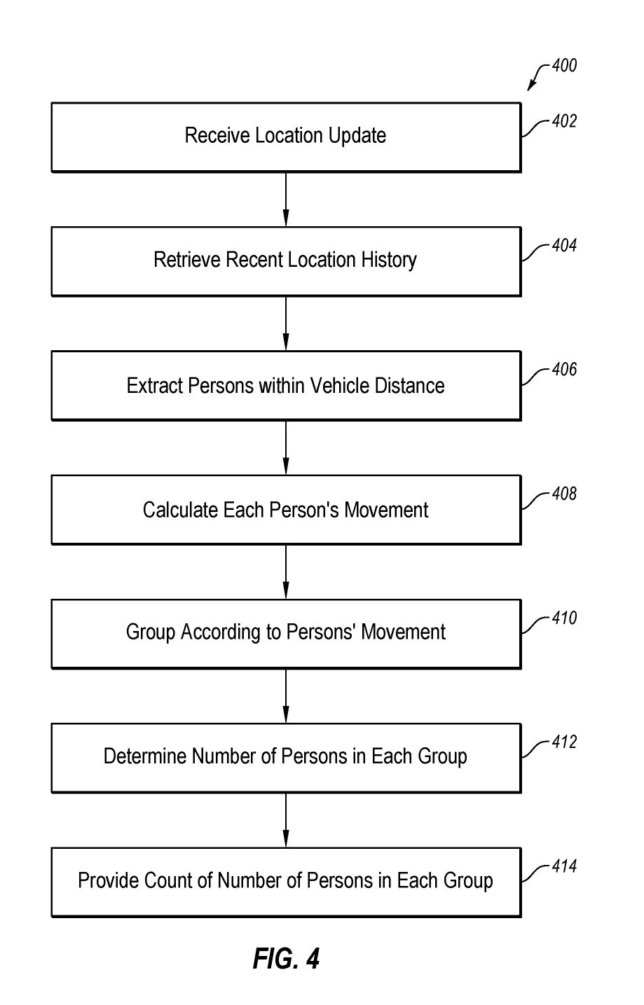

FIG. 4 is a flow diagram 400 that illustrates an example process to determine a number of persons in a transportation vehicle, arranged in accordance with at least some embodiments described herein. Example processes and methods may include one or more operations, functions or actions as illustrated by one or more of blocks 402, 404, 406, 408, 410, 412, and/or 414, and may in some embodiments be performed by a computing system such as computing system 300 of FIG. 3. The operations described in blocks 402-414 may also be stored as computer-executable instructions in a computer-readable medium such as memory 304 and/or data storage 306 of computing system 300.

As depicted by flow diagram 400, the example process to determine a number of persons in a transportation vehicle may begin with block 402 (“Receive Location Update”), where occupancy detection module 204 of occupancy detection system 102 may receive a location update from location history data store 202. For example, location history data store 202 may invoke occupancy detection module 204 with the location update upon receiving location, speed, acceleration, and time information from a remote mobile device in the possession of a person. The location update may include the received identifier, location, speed, acceleration, and time information, thus allowing occupancy detection module 204 to identify the person associated with the location update.

Block 402 may be followed by block 404 (“Retrieve Recent Location History”), where occupancy detection module 204 may retrieve records (e.g., the identifier, location, speed, acceleration, and time information entries) from location history data store 202 that indicate or are associated with a time sufficiently close to the time indicated in the location update.

Block 404 may be followed by block 406 (“Extract Persons within Vehicle Distance”), where occupancy detection module 204 may identify or determine, from the retrieved records, the records that indicate a location that is within a specific distance from the location indicated in the location update. For example, the specific distance may be approximate to the dimensions of a transportation vehicle. In some embodiments, the specific distance may be approximate to the dimensions of two transportation vehicles placed side-by-side. In some embodiments, the specific distance may be approximate to the dimensions of two transportation vehicles placed front-to-back. In some embodiments, the specific distance may be approximate to the dimensions of four transportation vehicles placed side-by-side and front-to-back. Occupancy detection module 204 may identify or determine the persons that are within the specific distance based on the identifiers of the identified records and the identifier of the location update.

Block 406 may be followed by block 408 (“Calculate Each Person's Movement”), where occupancy detection module 204 may calculate or determine the movement (e.g., velocity and acceleration) of each person that is within the specific distance as determined in block 406. For example, occupancy detection module 204 may calculate or determine the movement of each person using or based on the speed and acceleration information of each person.

Block 408 may be followed by block 410 (“Group According to Persons' Movement”), where occupancy detection module 204 may group the persons that are within the specific distance (as determined in block 406) based on the movement of each person (as determined in block 408). The movement of each person may indicate that the persons are in one or more groups or transportation vehicles. Occupancy detection module 204 may conclude that the persons are in one or more transportation vehicles based on a comparison of the speed and acceleration information of each person. For example, the acceleration information of two persons may be different enough to conclude that the two persons are traveling in two different transportation vehicles. In another example, the location information for three persons may be such that the three persons may be within the specific distance, but the acceleration information may be different enough to conclude that the three persons are traveling in three different transportation vehicles (e.g., the first person is heading to north, the second person is heading east, and the third person is heading south).

Block 410 may be followed by block 412 (“Determine Number of Persons in Each Group”), where occupancy detection module 204 may determine the number of persons in each group. Occupancy detection module 204 may determine the number of persons (e.g., occupants) in each of the one or more groups (e.g., each of the one or more transportation vehicles).

Block 412 may be followed by block 414 (“Provide Count of Number of Persons in Each Group”), where occupancy detection module 204 may provide the count of the number of persons in each group to one or more persons in each group. For example, for each transportation vehicle, occupancy detection module 204 may provide the count of the number of occupants in a transportation vehicle to a person (e.g., the application on the mobile device of the person) in the transportation vehicle. In some embodiments, occupancy detection module 204 may provide the count of the number of occupants in a transportation vehicle to more than one person in the transportation vehicle.

Those skilled in the art will appreciate that the logic illustrated in flow diagram 400, and in each of the sequence and flow diagrams discussed below, is only provided as an example and may be altered in various ways. For example, the order of the logic may be rearranged, subactions may be performed in parallel or combined into fewer operations, illustrated logic may be omitted, other logic may be included, etc., without detracting from the spirit and scope of the disclosed embodiments.

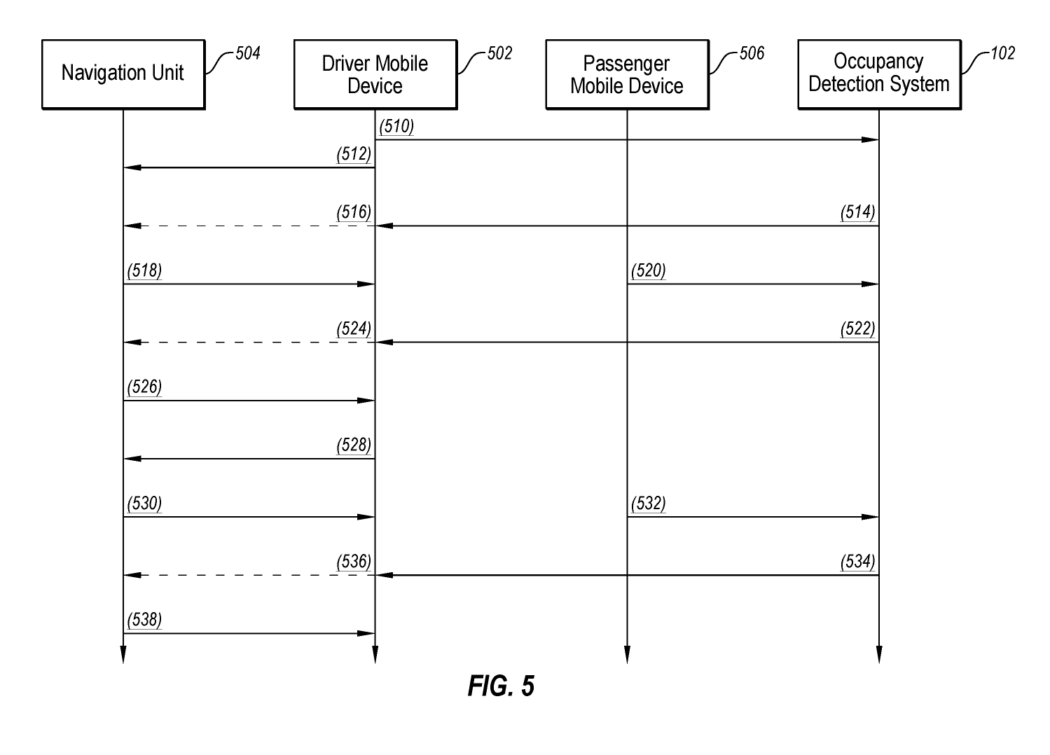

FIG. 5 is a sequence diagram illustrating flows of information to provide high-occupancy vehicle (HOV) lane aware navigation, arranged in accordance with at least some embodiments described herein. FIG. 5 illustrates an example where a driver mobile device 502, a navigation unit 504, and a passenger mobile device 506 may interact with occupancy detection system 102 to enable navigation unit 504 provide HOV lane aware navigation. The illustrated example describes one application or use of the technology, and other applications and uses are envisioned.

A driver may enter a transportation vehicle (e.g., an automobile) and start executing an occupancy detection application program on driver mobile device 502 of the driver. In response, driver mobile device 502 may start periodically transmitting (510) its identifier, location, speed, acceleration and time information to occupancy detection system 102. Execution of the occupancy detection application program may also cause driver mobile device 502 to connect (512) to navigation unit 504 using a suitable wireless communications technology, such as, by way of example, Bluetooth. Navigation unit 504 may be configured to provide route guidance using HOV lanes.

Upon receiving the identifier, location, speed, acceleration and time information provided by driver mobile device 502, occupancy detection system 102 may determine the occupants in the transportation vehicle with the driver, and may send (514) a count of the number of occupants in the transportation vehicle to driver mobile device 502. For example, as the driver is the only occupant at the present time, the count of the number of occupants is 1. Driver mobile device 502 may forward (516) the count of the number of occupants in the transportation vehicle to navigation unit 504. Navigation unit 504 may determine that the transportation vehicle is not eligible to use HOV lanes based on the count of the number of occupants in the transportation vehicle, and provide (518) route guidance that does not include the use of HOV lanes.

Driver mobile device 502 may be periodically transmitting its identifier, location, speed, acceleration and time information to occupancy detection system 102, and receiving corresponding counts of the number of occupants in the transportation vehicle from occupancy detection system 102. In some embodiments, driver mobile device 502 may not forward the count of the number of occupants in the transportation vehicle to navigation unit 504 if there is no change to the count. That is, driver mobile device 502 may forward the count of the number of occupants in the transportation vehicle to navigation unit 504 if the count of the number of occupants in the transportation vehicle changed.

While driving, the driver may stop to pick up a passenger. The passenger may enter the transportation vehicle and start executing the occupancy detection application program on mobile device 506 of the passenger. In response, passenger mobile device 506 may start periodically transmitting (520) its identifier, location, speed, acceleration and time information to occupancy detection system 102. Upon receiving the identifier, location, speed, acceleration and time information provided by passenger mobile device 506, occupancy detection system 102 may determine the occupants in the transportation vehicle with the passenger, and may determine that the passenger and the driver are in the same transportation vehicle. Occupancy detection system 102 may send (522) a count of the number of occupants in the transportation vehicle to driver mobile device 502. Occupancy detection system 102 may also send the count of the number of occupants in the transportation vehicle to passenger mobile device 506. For example, as the driver and the passenger are occupying the transportation vehicle at the present time, the count of the number of occupants is 2. Driver mobile device 502 may forward (522) the count of the number of occupants in the transportation vehicle to navigation unit 504.

Navigation unit 504 may determine that the transportation vehicle is now eligible to use HOV lanes based on the count of the number of occupants in the transportation vehicle, and provide (526) an option to use HOV lanes (e.g., include the use of HOV lanes in the route guidance). For example, navigation unit 504 may provide a dialog on its display asking whether the use of HOV lanes should be included in the route guidance. The driver may respond (528) to the option to use HOV lanes, and navigation unit 504 may provide (530) route guidance based on the response of the driver. For example, if the response of the driver is to use HOV lanes, navigation unit 504 may provide route guidance that includes the use of available HOV lanes. Conversely, if the response of the driver is to not use HOV lanes, navigation unit 504 may continue to provide route guidance that does not include the use of HOV lanes.

Subsequently, the driver may stop to drop off the passenger. As a result of the passenger getting off the transportation vehicle, passenger mobile device 506 may be transmitting (532) location, speed, and acceleration information that differs from the location, speed, and acceleration information being transmitted by driver mobile device 502. Upon receiving the identifier, location, speed, acceleration and time information provided by passenger mobile device 506, occupancy detection system 102 may determine that the passenger and driver are no longer in the same transportation vehicle. Occupancy detection system 102 may send (534) a count of the number of occupants in the transportation vehicle to driver mobile device 502. For example, as the driver is the only occupant at the present time, the count of the number of occupants is 1. Driver mobile device 502 may forward (536) the changed count of the number of occupants in the transportation vehicle to navigation unit 504. Navigation unit 504 may determine that the transportation vehicle is no longer eligible to use HOV lanes based on the count of the number of occupants in the transportation vehicle, and provide (538) route guidance that does not include the use of HOV lanes.

In some embodiments, navigation unit 504 may provide an option to continue receiving route guidance upon determining that the transportation vehicle is no longer eligible to use HOV lanes. For example, navigation unit 504 may provide a dialog on its display informing that HOV lanes can no longer be used, and asking whether route guidance without the use of HOV lanes should still be provided. Based on the response, navigation unit 504 may either provide route guidance that does not include the use of available HOV lanes or not provide any route guidance.

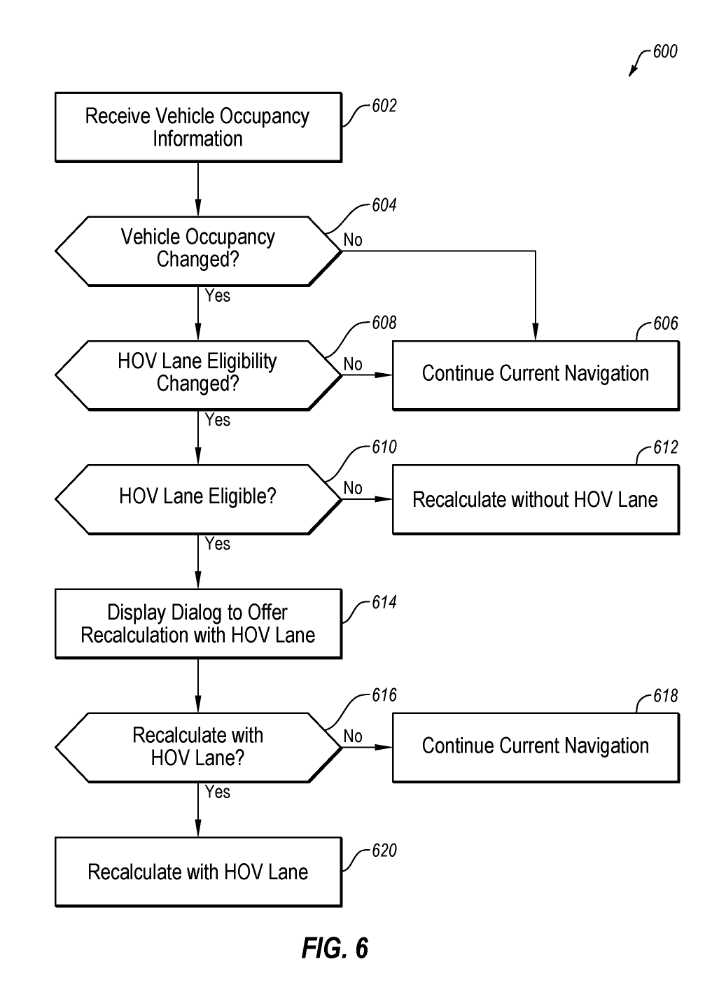

FIG. 6 is a flow diagram 600 that illustrates an example process to provide HOV lane aware navigation, arranged in accordance with at least some embodiments described herein. Example processes and methods may include one or more operations, functions or actions as illustrated by one or more of blocks 602, 604, 606, 608, 610, 612, 614, 616, 618 and/or 620, and may in some embodiments be performed by a computing system, such as computing system 300 of FIG. 3, of a vehicle navigation system. The operations described in blocks 602-620 may also be stored as computer-executable instructions in a computer-readable medium such as memory 304 and/or data storage 306 of computing system 300.

As depicted by flow diagram 600, the example process to provide HOV lane aware navigation may begin with block 602 (“Receive Vehicle Occupancy Information”), where a vehicle navigation device, such as, by way of example, navigation unit 504 that is providing route guidance, may receive a count of a number of occupants in a transportation vehicle. For example, a driver of the transportation vehicle may be executing an occupancy detection application program on the mobile device of the driver, and the mobile device may provide the count of the number of occupants to the vehicle navigation device.

Block 602 may be followed by decision block 604 (“Vehicle Occupancy Changed?”), where the vehicle navigation device may determine whether there is a change in the number of occupants in the transportation vehicle based on the received count of the number of occupants. If the vehicle navigation device determines that there is no change in the number of occupants in the transportation vehicle, decision block 604 may be followed by block 606 (“Continue Current Navigation”), where the vehicle navigation device may continue to provide the current route guidance. For example, the current route guidance may include the HOV lanes if the number of occupants in the transportation vehicle qualifies for the use of HOV lanes. Conversely, the current route guidance may not include the HOV lanes if the number of occupants in the transportation vehicle do not qualify for the use of HOV lanes.

Otherwise, if the vehicle navigation device determines that there is a change in the number of occupants in the transportation vehicle, decision block 604 may be followed by decision block 608 (“HOV Lane Eligibility Changed?”), where the vehicle navigation device may determine whether the change in the number of occupants results in a change to the HOV lane eligibility. That is, whether the new or updated count of the number of occupants results in the transportation vehicle going from not eligible to use HOV lanes to eligible to use HOV lanes, or eligible to use HOV lanes to not eligible to use HOV lanes. If the vehicle navigation device determines that the change in the number of occupants does not result in a change to the HOV lane eligibility, decision block 608 may be followed by block 606 (“Continue Current Navigation”), where the vehicle navigation device may continue to provide the current route guidance.

Otherwise, if the vehicle navigation device determines that the change in the number of occupants does result in a change to the HOV lane eligibility, decision block 608 may be followed by decision block 610 (“HOV Lane Eligible?”), where the vehicle navigation device may determine whether the transportation vehicle is eligible to use HOV lanes. That is, whether the number of occupants (e.g., the changed number) qualifies for using HOV lanes. If the vehicle navigation device determines that the transportation vehicle is not eligible to use HOV lanes, decision block 610 may be followed by block 612 (“Recalculate without HOV Lane”), where the vehicle navigation device may recalculate the route guidance without including the use of HOV lanes. For example, the current route guidance may have included the use of HOV lanes, and the vehicle navigation device recalculates this route guidance to no longer include the use of HOV lanes.

Otherwise, if the vehicle navigation device determines that the transportation vehicle is eligible to use HOV lanes, decision block 610 may be followed by block 614 (“Display Dialog to Offer Recalculation with HOV Lane”), where the vehicle navigation device may display a dialog to offer recalculation of the current route guidance to include the use of available HOV lanes. For example, the vehicle navigation device may display on its display device a dialog informing the driver of the option to include HOV lanes in the route guidance.

Block 614 may be followed by decision block 616 (“Recalculate with HOV Lane?”), where the vehicle navigation device may determine whether or not to recalculate the current route guidance to include the use of available HOV lanes. If the vehicle navigation device determines to not recalculate (e.g., the response of the driver is to not include HOV lanes in the route guidance), decision block 616 may be followed by block 618 (“Continue Current Navigation”), where the vehicle navigation device may continue to provide the current route guidance. For example, the current route guidance may not have included the use of HOV lanes, and the vehicle navigation device continues to provide this route guidance.

Otherwise, if the vehicle navigation device determines to recalculate (e.g., the response of the driver is to include HOV lanes in the route guidance), decision block 616 may be followed by block 620 (“Recalculate with HOV Lane”), where the vehicle navigation device may recalculate the route guidance to include the use of available HOV lanes. For example, the current route guidance may not have included the use of HOV lanes, and the vehicle navigation device recalculates this route guidance to include the use of HOV lanes. The vehicle navigation device may then provide the route guidance that includes the use of available HOV lanes.

In some embodiments, the technology may be integrated with an automatic toll road payment system. Similar to the HOV lane aware navigation application discussed above in conjunction with FIG. 5, the occupancy detection application program may be configured to communicate with an automatic toll payment system where the applicable toll is based on the number of passengers in a vehicle. In this application of the technology, the occupancy detection application program may be configured to determine a toll payment amount based on a number of occupants in a transportation vehicle, and automatically make the toll payment.

In some embodiments, the technology may be integrated with a ride share system. Similar to the HOV lane aware navigation application discussed above in conjunction with FIG. 5, the occupancy detection application program may be configured to communicate with a ride share fee payment system where the fee for riding in a vehicle is based on the number of passengers in the vehicle. In this application of the technology, the occupancy detection application program may be configured to determine a ride share fee amount based on a number of occupants in a transportation vehicle, and automatically make the ride share fee payment.

As indicated above, the embodiments described in the present disclosure may include the use of a special purpose or general purpose computer (e.g., processor 302 of FIG. 3) including various computer hardware or software modules, as discussed in greater detail herein. Further, as indicated above, embodiments described in the present disclosure may be implemented using computer-readable media (e.g., memory 304 of FIG. 3) for carrying or having computer-executable instructions or data structures stored thereon.

According to some examples, systems configured to determine number of occupants in a transportation vehicle are described. An example system configured to determine number of occupants in a transportation vehicle may include a memory configured to store instructions and a processor configured to execute the instructions. Execution of the instructions may cause the processor to receive an indication of a first location, a first speed, a first acceleration, and a first time, where the indication of the first location, the first speed, the first acceleration, and the first time may be associated with a first device; receive an indication of a second location, a second speed, a second acceleration, and a second time, where the indication of the second location, the second speed, the second acceleration, and the second time may be associated with a second device; and determine whether the first device and the second device are in a same transportation vehicle based on a comparison of the first location, first speed, first acceleration, and first time with the second location, second speed, second acceleration, and second time, respectively.

According to some examples, execution of the instructions may cause the processor to maintain a count of the number of occupants in the same transportation vehicle based on the determination of whether the first device and the second device are in the same transportation vehicle. In some examples, the count of the number of occupants in the same transportation vehicle may be used to determine high-occupancy vehicle (HOV) lane navigation for the same transportation vehicle. In other examples, the count of the number of occupants in the same transportation vehicle may be used to determine a toll amount for the same transportation vehicle. In further examples, the count of the number of occupants in the same transportation vehicle may be used to determine a ride share fee for occupants in the same transportation vehicle.

In some examples, the first device may correspond to one occupant. In other examples, the first device may correspond to a multiple number of occupants. In still other examples, the first device may correspond to a multiple number of occupants, and the multiple number of occupants may be determined based on visual information obtained by the first device.

According to other examples, methods to determine number of occupants in a transportation vehicle are described. An example method to determine number of occupants in a transportation vehicle may include receiving an indication of a first location, a first speed, a first acceleration, and a first time, where the indication of the first location, the first speed, the first acceleration, and the first time may be associated with a first device; receiving an indication of a second location, a second speed, a second acceleration, and a second time, where the indication of the second location, the second speed, the second acceleration, and the second time may be associated with a second device; determining whether the first device and the second device are in a same transportation vehicle based on a comparison of the first location, first speed, first acceleration, and first time with the second location, second speed, second acceleration, and second time, respectively; and incrementing by one a count of a number of occupants in the same transportation vehicle responsive to a determination that the first device and the second device are in the same transportation vehicle.

In some examples, the first device may be a smartphone within the same transportation vehicle. In other examples, the first device is a smartphone within the same transportation vehicle, and the indication of the first location, the first speed, the first acceleration, and the first time may be provided by an application executing on the smartphone.

In still other examples, the method may also include indicating the first device and the second device as being in a same group responsive to a determination that the first device and the second device are in the same transportation vehicle. In further examples, the method may further include decrementing by one the count of the number of occupants in the same transportation vehicle responsive to a determination that a device previously identified as being in the same transportation vehicle is no longer in the same transportation vehicle. In some examples, the count of the number of occupants in the same transportation vehicle may result in the same transportation vehicle no longer being navigated using high-occupancy vehicle (HOV) lanes.

In some examples, the method may include providing the count of the number of occupants in the same transportation vehicle to a navigation system associated with the same transportation vehicle. In other examples, the method may include providing the count of the number of occupants in the same transportation vehicle to a toll collection system.

According to still other examples, non-transitory computer-readable storage medium storing thereon instructions that may be executed by a processor are described. An example non-transitory computer-readable storage media may store thereon instructions that, in response to execution by a processor, causes the processor to receive an indication of a first location, a first speed, and a first acceleration, where the indication of the first location, the first speed, and the first acceleration may be associated with a first device; associate a first time with the indication of the first location, the first speed, and the first acceleration; receive an indication of a second location, a second speed, and a second acceleration, where the indication of the second location, the second speed, and the second acceleration may be associated with a second device; associate a second time with the indication of the second location, the second speed, and the second acceleration; and determine whether the first device and the second device are in a same transportation vehicle based on a comparison of the first location, first speed, first acceleration, and first time with the second location, second speed, second acceleration, and second time, respectively.

In some examples, the indication of the first location, the first speed, and the first acceleration may be provided by an application executing on a smartphone, where the smartphone may be in possession of an occupant in the same transportation vehicle. In other examples, the example non-transitory computer-readable storage media may store thereon instructions that, in response to execution by a processor, causes the processor to maintain a count of the number of occupants in the same transportation vehicle based on the determination of whether the first device and the second device are in the same transportation vehicle.

As used in the present disclosure, the terms “module” or “component” may refer to specific hardware implementations configured to perform the actions of the module or component and/or software objects or software routines that may be stored on and/or executed by general purpose hardware (e.g., computer-readable media, processing devices, etc.) of the computing system. In some embodiments, the different components, modules, engines, and services described in the present disclosure may be implemented as objects or processes that execute on the computing system (e.g., as separate threads). While some of the system and methods described in the present disclosure are generally described as being implemented in software (stored on and/or executed by general purpose hardware), specific hardware implementations, firmware implements, or any combination thereof are also possible and contemplated. In this description, a “computing entity” may be any computing system as previously described in the present disclosure, or any module or combination of modulates executing on a computing system.

Terms used in the present disclosure and in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

All examples and conditional language recited in the present disclosure are intended for pedagogical objects to aid the reader in understanding the present disclosure and the concepts contributed by the inventor to furthering the art, and are to be construed as being without limitation to such specifically recited examples and conditions. Although embodiments of the present disclosure have been described in detail, various changes, substitutions, and alterations could be made hereto without departing from the spirit and scope of the present disclosure.

What is claimed is:

1. A system configured to determine a number of occupants in a transportation vehicle, the system comprising:
a memory configured to store instructions; and
a processor configured to execute the instructions, execution of the instructions causes the processor to:
receive a first indication of a first location, a first speed, a first acceleration, and a first time, the first indication being associated with a first device;
receive a second indication of a second location, a second speed, a second acceleration, and a second time, the second indication being associated with a second device; and
determine whether the first device and the second device are in the transportation vehicle based on a comparison of the first indication and the second indication.

2. The system of claim 1, wherein execution of the instructions further causes the processor to maintain a count of the number of occupants in the transportation vehicle based on the determination of whether the first device and the second device are in the transportation vehicle.

3. The system of claim 2, wherein the count of the number of occupants in the transportation vehicle is used to determine high-occupancy vehicle (HOV) lane navigation for the transportation vehicle.

4. The system of claim 2, wherein the count of the number of occupants in the transportation vehicle is used to determine a toll amount for the transportation vehicle.

5. The system of claim 2, wherein the count of the number of occupants in the transportation vehicle is used to determine a ride share fee for the occupants in the transportation vehicle.

6. The system of claim 1, wherein the first device corresponds to one occupant.

7. The system of claim 1, wherein the first device corresponds to a plurality of occupants.

8. The system of claim 7, wherein the plurality of occupants are determined based on acoustic information obtained by the first device.

9. The system of claim 7, wherein the plurality of occupants are determined based on visual information obtained by the first device.

10. A method to determine a number of occupants in a transportation vehicle, the method comprising:
receiving a first indication of a first location, a first speed, a first acceleration, and a first time, the first indication being associated with a first device;
receiving a second indication of a second location, a second speed, a second acceleration, and a second time, the second indication being associated with a second device;
determining whether the first device and the second device are in the transportation vehicle based on a comparison of the first indication and the second indication; and
incrementing by one a count of a number of occupants in the transportation vehicle responsive to a determination that the first device and the second device are in the transportation vehicle.

11. The method of claim 10, wherein the first device is a smartphone within the transportation vehicle.

12. The method of claim 11, wherein the first indication is provided by an application executing on the smartphone.

13. The method of claim 10, further comprising indicating the first device and the second device as being in a same group responsive to a determination that the first device and the second device are in the transportation vehicle.

14. The method of claim 10, further comprising decrementing by one the count of the number of the occupants in the transportation vehicle responsive to a determination that a device previously identified as being in the transportation vehicle is no longer in the transportation vehicle.

15. The method of claim 14, wherein the count of the number of occupants in the transportation vehicle results in the transportation vehicle no longer being navigated using high-occupancy vehicle (HOV) lanes.

16. The method of claim 10, further comprising providing the count of the number of the occupants in the transportation vehicle to a navigation system associated with the transportation vehicle.

17. The method of claim 10, further comprising providing the count of the number of the occupants in the transportation vehicle to a toll collection system.

18. A non-transitory computer-readable storage medium storing thereon instructions that, in response to execution by a processor, causes the processor to:
receive a first indication of a first location, a first speed, and a first acceleration, the first indication being associated with a first device;
associate a first time with the first indication;
receive a second indication of a second location, a second speed, and a second acceleration, the second indication;
associate a second time with the second indication; and
determine whether the first device and the second device are in a same transportation vehicle based on a comparison of the first indication and the second indication.

19. The non-transitory computer-readable storage medium of claim 18, wherein the first indication is provided by an application executing on a smartphone, the smartphone being in possession of an occupant in the transportation vehicle.

20. The non-transitory computer-readable storage medium of claim 18, further storing thereon instructions that, in response to execution by the processor, causes the processor to maintain a count of the number of the occupants in the transportation vehicle based on the determination of whether the first device and the second device are in the transportation vehicle.
